(19) United States
(12) Patent Application Publication
(10) Pub. No.: US 2010/0064722 A1
(43) Pub. Date: Mar. 18, 2010

(54) REFRIGERANT SYSTEM WITH PULSE WIDTH MODULATION FOR REHEAT CIRCUIT

(76) Inventor: Michael F. Taras, Fayetteville, NY (US)

Correspondence Address: CARLSON, GASKEY & OLDS, P.C., 400 WEST MAPLE ROAD, SUITE 350, BIRMINGHAM, MI, 48009, US

(21) Appl. No.: 12/374,328

(22) PCT Filed: Jul. 19, 2006
(86) PCT No.: PCT/US06/27946

§ 371 Date: Jan. 19, 2009

(51) Int. Cl. F25B 1/00; F25B 41/04; G05D 7/00; F01C 1/02; F24F 3/14

(52) U.S. Cl. 62/498; 62/513; 700/282; 418/55.1; 236/44 C

(57) ABSTRACT

A refrigerant system incorporating a reheat circuit is also provided with pulse width modulation control to adjust the amount of refrigerant being compressed. In particular, in any dehumidification mode of operation, by activating the pulse width modulation control, sensible and latent components of capacity can be controlled independently and with significantly better accuracy. The present invention provides the ability to precisely tailor both humidity and temperature control to the conditioned space demands utilizing less expensive components and in a more efficient manner than in the prior art.

### BACKGROUND OF THE INVENTION

This application relates to a pulse width modulation control for a refrigerant system with a reheat circuit.

Refrigerant systems are known and utilized to provide and maintain desired temperature and humidity levels of air being delivered into a conditioned environment. Examples would include air conditioners and heat pumps of various configurations and design schematics. As known, the refrigerant system acts to change the temperature of the air being delivered into the environment to match a desired temperature. Further, the refrigerant system controls the humidity level in the environment, typically within the comfort zone.

Various operational features and enhancement options are known for providing adjustments in refrigerant system capacity. One approach, which has been utilized in the prior art to change the capacity of a conventional refrigerant system, is the use of a pulse width modulation technique to control a valve on a compressor suction line from a fully open to a fully closed position. By cycling this valve at a certain rate, utilizing a pulse width modulation approach, an additional degree of capacity control is provided for a refrigerant system in a very efficient manner. Since the pulse width modulation technique maintains compressor operation between fully loaded and fully unloaded states, ideally, no additional losses are incurred during such part-load operation of a refrigerant system, in comparison to other known unloading methods such as suction throttling, hot gas bypass, etc.

One other variation of the pulse width modulation approach mentioned above is an employment of a scroll compressor, wherein a pulse width modulation technique is utilized to allow the scroll compressor members to be moved into and out of contact with each other at a certain periodic rate. As above, when the scroll members are out of engagement, little or no compression occurs. On the other hand, when the scroll members are in contact with each other, full-load operation is resumed. Once again, since the compressor is operated between loaded and unloaded states, only a minimal additional loss is incurred.

One other type of control provided in a refrigerant system is dehumidification control delivered by a reheat circuit. A reheat circuit typically taps refrigerant at a temperature somewhat higher than the temperature of refrigerant in an evaporator. When a reheat circuit is activated, the evaporator cools air being delivered into a conditioned environment to a temperature below the desired temperature. This allows for a greater moisture removal potential from the supply airstream, while the air passes over the evaporator. Downstream the overcooled and dehumidified air flows over a reheat heat exchanger, where its temperature is raised back to a desired level, but now at a lower humidity.

As known, there are a number of variations of dehumidification system schematics for providing such reheat control. For instance, one widely used concept employs hot refrigerant vapor exiting compressor discharge port. An alternative popular approach involves a subcooled liquid, or a two-phase refrigerant mixture utilized for reheat purposes. Although all of these various schemes typically provide only a step function (on or off) to switch between conventional cooling and the utilization of a reheat circuit, attempts have been made in the past to split and/or regulate refrigerant flow between the main circuit and the reheat branch to provide finer control than “full off” or “full on” operation. These attempts have faced some challenges in terms of system reliability, stability and robustness.

Recently, an invention of the assignee of the present invention proposed to utilize variable speed drives for various components such as compressors or fans to allow for refrigerant and airflow variations to adjust performance of a reheat circuit. However, these attempts would not always provide fully satisfactory results and cover a somewhat narrow range of applications. Further, regulatory requirements, concerning minimum fresh air circulation rates in a conditioned space, made this task even more difficult to accomplish. Also, there are efficiency losses and reliability concerns associated with variable speed drives.

On the other hand, the pulse width modulation techniques mentioned above allow for a wide range of control to the provided capacity, and in many cases can be executed less expensively and more efficiently than the use of a variable speed drive approach.

Further, in a co-pending PCT application owned by the assignee of the present invention and entitled “SYSTEM REHEAT CONTROL BY PULSE WIDTH MODULATION” and identified by PCT Serial No. US05/30603, a technique is disclosed for utilizing pulse width modulation to control the opening and closing of the valve that taps refrigerant into the reheat circuit. While the disclosed method provides greater refrigerant system capacity control, other advanced methods of achieving similar control have been devised.

### SUMMARY OF THE INVENTION

In the disclosed embodiment of this invention, a pulse width modulation control is incorporated into a refrigerant system having a reheat circuit. In one embodiment, the pulse width modulation control device is positioned on a suction line delivering the refrigerant to the compressor. By controlling the amount of refrigerant being directed to the compressor, while the reheat mode is activated, an advanced finer dehumidification control is provided than as in the past. The pulse width modulation becomes a very effective instrument for controlling refrigerant flow, which allows for independent and accurate control of sensible and latent components of capacity in response to a constantly changing thermal load in a conditioned space. The technique is similar to utilizing a variable speed compressor to control the sensible and latent capacity, but achieves this control at a much lower cost, reduced complexity and higher efficiency. The pulse width modulation concept provides a straightforward method to achieve the desired dehumidification results by varying a sensible heat ratio in combination with the activation of a reheat function. This allows for enhanced humidity control and flexibility in system operation over a wide range of environmental conditions, while any mechanical dehumidification/reheat concept can be utilized. As a result, the proposed approach reduces variation in temperature and humidity in a conditioned space and subsequently improves the comfort of an occupant.

In a disclosed embodiment, a valve for bypassing at least a portion of refrigerant around a condenser may also be controlled utilizing a pulse width modulation technique. Typically, this condenser bypass provides refrigerant at a higher temperature to the condenser exit and is engaged when dehumidification with less sensible cooling is required in a conditioned environment. When at least a portion of refrigerant is bypassing the condenser, more heat is rejected by a reheat coil into the airstream delivered to a conditioned space and thus less overall sensible cooling will be provided to the air.

In another embodiment, the pulse width modulation to control the amount of refrigerant being delivered through the refrigerant system having a reheat circuit occurs in a scroll compressor, and allows the compressor scroll members to engage and disengage to control the amount of refrigerant being delivered through the refrigerant system. When the scroll members are out of engagement, little or no compression occurs. On the other hand, when the scroll members are in contact with each other, full-load operation is resumed.

These and other features of the present invention can be best understood from the following specification and drawings, the following of which is a brief description.

### BRIEF DESCRIPTION OF THE DRAWINGS

FIG. 1 shows one example schematic of a refrigerant system.

FIG. 2 shows an alternative method of providing pulse width modulation control to a compressor.

### DETAILED DESCRIPTION OF THE PREFERRED EMBODIMENT

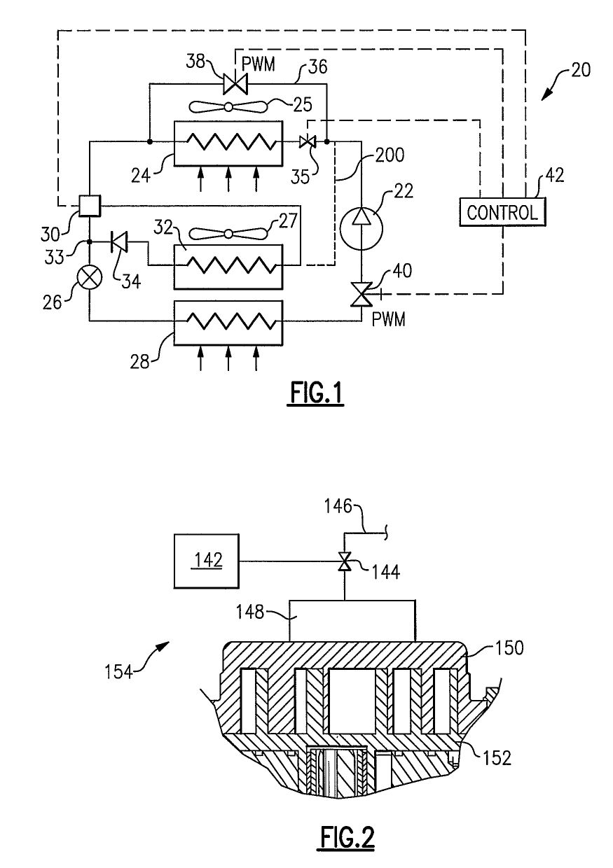

A refrigerant system 20 is illustrated in FIG. 1 incorporating a compressor 22 compressing a refrigerant and delivering it downstream to a condenser 24. An expansion device 26 is positioned downstream of the condenser 24, and an evaporator 28 is positioned downstream of the expansion device 26. Refrigerant circulates between these four basic components, as known. A fan 25 moves air over the condenser 24.

The refrigerant system 20 is also provided with a reheat circuit. The reheat circuit incorporates a three-way valve 30 for selectively delivering refrigerant into and through a reheat heat exchanger 32. A check valve 34 ensures that refrigerant only flows from the valve 30 through the heat exchanger 32 and through the check valve 34 unidirectionally, and re-enters the main refrigerant circuit at a junction point 33. As illustrated, the refrigerant is tapped through the reheat heat exchanger 32 downstream of the condenser 24, and is returned upstream of the expansion device 26. This is only one example and is illustrative of the reheat circuit schematics, and many other configurations are feasible. Reheat circuit methods are known which tap refrigerant from any location upstream or downstream of the condenser coil 24 and return the refrigerant to any location upstream of the expansion device 26 within the refrigerant system 20. The present invention would extend to any of those methods. As an example, an alternative inlet 200 into the reheat circuit with the heat exchanger upstream the condenser is shown in phantom in FIG. 1.

Another feature illustrated in the FIG. 1 embodiment is a condenser bypass line 36 having a bypass valve 38. Bypass line 36 bypasses at least a portion of refrigerant around the condenser 24 when the bypass valve 38 is opened. This would occur when dehumidification is to be performed with the reduced sensible cooling demand in a conditioned space. When at least a portion of refrigerant is bypassing the condenser 24, more heat is rejected by a reheat coil into the airstream delivered to a conditioned space, and thus less overall sensible cooling will occur to the air as it would be if it had passed through the condenser 24. A shutoff valve 35 is provided upstream of the condenser 24 in case it is desired for the entire refrigerant flow to bypass the condenser 24.

As is known, a fan 27 moving air over the evaporator 28 also moves air over the reheat heat exchanger 32. A control 42 for the refrigerant system 20 will generally operate the reheat circuit to provide reheat function when dehumidification is desirable with less or no sensible cooling. Generally, the control 42 operates the refrigerant system 20 such that the refrigerant in the evaporator 28, controlled as known, would lower the temperature of the supply airstream below the desired temperature in the environment to be conditioned. In this manner, additional moisture can be removed from the air to satisfy humidity level in the conditioned environment. The air then passes serially over the reheat heat exchanger 32 and is heated back up to the target temperature, since the refrigerant in the reheat heat exchanger 32 is somewhat hotter than the refrigerant in the evaporator 28. The air having been reheated by the reheat heat exchanger 32 already has lower humidity such that the air will now have the desired temperature and desired humidity levels.

The condenser bypass line 36 and bypass valve 38 may be operated, as known, to further provide precise humidity and temperature control. This bypass is typically operated when the sensible cooling load is relatively low, but dehumidification (latent load) is still desirable. Again, the function of such a bypass and its operation to provide variable sensible heat ratios are known.

The present invention relates to the use of pulse width modulation controls for the valve 40 and also the bypass valve 38. The pulse width modulation allows each of these valves to be cycled at a predetermined variable rate (which generally is different for each valve) and controlling the amount of refrigerant passing through. Pulse width modulation allows for control of the refrigerant flow from approximately 5% to 100% of the refrigerant flow at a fully open valve position. Thus, by cycling these valves at specified variable rates, the amount of refrigerant passing through the main circuit of the refrigerant system 20 and through its branches, and hence the amount of cooling and dehumidification provided to a conditioned environment, can be precisely controlled.

When the refrigerant system 20 operates in a conventional cooling mode (the reheat branch and condenser bypass are typically not active), the pulse width modulation valve 40 offers the means of overall cooling capacity adjustment by varying the cycling rate and engagement time interval. Consequently, when time-averaged refrigerant flow delivered by the compressor 22 is reduced, the refrigerant saturation suction temperature decreases as well. As a result, although overall refrigerant system capacity is reduced, the evaporator 28 would provide better relative dehumidification capability and operation at a variable sensible heat ratio. On the other hand, an absolute amount of moisture being removed from the airstream may be reduced. Therefore, in the conventional mode of operation, although pulse width modulation technique presents a significant opportunity to provide part-load performance over a wide range of capacities, system dehumidification capability control is narrow and restricted.

When the reheat branch of the refrigerant system 20 is engaged, the dehumidification mode is activated, and significant moisture removal occurs in the evaporator 28. In this mode of operation, overall system sensible cooling capacity is noticeably reduced, but not completely counterbalanced by the reheat coil 32. Once again, the pulse width modulation valve 40 allows for the fine-tuning of both sensible and latent capacity components, but now around a different operational point provided by a reheat function.

Further, when the condenser bypass is activated, it provides a further means of sensible capacity reduction and system dehumidification operation in the vicinity of a neutral sensible capacity point. As before, the pulse width modulation valve 40 offers fine sensible and latent capacity adjustments. Moreover, if the bypass valve 38 is controlled in a pulse width modulated manner as well, a sensible heat ratio can be varied over a wide spectrum of values to satisfy thermal load demands and application requirements. Note that without pulse width modulation control a true neutral sensible capacity may be achieved only at a single set of environmental conditions and, at off-design conditions, the refrigerant system 20 would provide either cooling or heating. Thus, integration of the pulse width modulation valves 40 and 38 into the system design allows for achieving neutral sensible capacity at a wide spectrum of operating conditions as well as independently adjust system cooling and dehumidification capability.

As a result of pulse width modulation control, variations of temperature and humidity in a conditioned environment can be greatly reduced, providing more comfort to the space occupant.

FIG. 2, as an example, shows a scroll compressor 154 including a non-orbiting scroll member 150 and an orbiting scroll member 152. As shown, a control 142 controls a pulse width modulation valve 144, which controls the flow of a pressurized fluid from a line 146 into a back pressure chamber 148. As is known, the back pressure chamber 148 holds the non-orbiting scroll member 150 against the orbiting scroll member 152. When the pulse width modulation valve 144 blocks the flow of this pressurized fluid, the scroll members are allowed to move away from each other and little or no compression occurs. On the other hand, when the back pressure chamber 148 is pressurized, the scroll members 150 and 152 are fully engaged for full-load operation. Since the compressor is operated between fully loaded and unloaded states, no significant additional losses are incurred. Again, this basic technique is known. However, the use of this technique in combination with a refrigerant system having a reheat circuit is novel over the prior art. Generally, the FIG. 2 compressor 154 would be substituted for the pulse width modulation suction valve 40 and compressor 22 of the FIG. 1 embodiment.

Although a preferred embodiment of this invention has been disclosed, a worker of ordinary skill in this art would recognize that certain modifications would come within the scope of this invention. For that reason, the following claims should be studied to determine the true scope and content of this invention.

1. A refrigerant system comprising:
a compressor for compressing refrigerant and delivering it downstream to a condenser, an expansion device positioned downstream of said condenser and an evaporator positioned downstream of said expansion device;
a reheat circuit incorporated into said refrigerant system, said reheat circuit being operable to tap at least a portion of refrigerant from a main refrigerant circuit and pass the refrigerant through a reheat heat exchanger, the refrigerant having passed through the reheat heat exchanger being returned to the main refrigerant circuit, an air-moving device for moving air over said evaporator, and then serially over said reheat heat exchanger; and
a component having pulse width modulation control for controlling the amount of refrigerant being compressed by said compressor, and a control for controlling said component to vary the amount of refrigerant passing from said compressor to achieve precise control over both temperature and humidity provided by the refrigerant system.

2. The refrigerant system as set forth in claim 1, wherein said component is a suction valve for controlling the amount of refrigerant delivered through said suction valve and to said compressor.

3. The refrigerant system as set forth in claim 1, wherein said component is the compressor, and the pulse width modulation control controlling the amount of refrigerant compressed by said compressor.

4. The refrigerant system as set forth in claim 3, wherein said compressor is a scroll compressor.

5. The refrigerant system as set forth in claim 1, wherein said reheat heat exchanger is positioned upstream of said condenser.

6. The refrigerant system as set forth in claim 1, wherein said reheat heat exchanger is positioned downstream of said condenser.

7. The refrigerant system as set forth in claim 1, wherein a bypass line and associated valve allow to bypass at least a portion of refrigerant around said condenser when less cooling is needed but dehumidification is still desirable.

8. The refrigerant system as set forth in claim 7, wherein said bypass valve is also provided with pulse width modulation control.

9. The refrigerant system as set forth in claim 7, wherein said at least a portion of refrigerant comprises entire refrigerant flow delivered by said compressor.

10. The refrigerant system as set forth in claim 1, wherein the pulse width modulation is controlled to provide neutral sensible capacity.

11. The refrigerant system as set forth in claim 1, wherein the pulse width modulation is controlled to provide variable sensible heat ratio.

12. The refrigerant system as set forth in claim 1, wherein the pulse width modulation is controlled to independently provide cooling and dehumidification.

13. The refrigerant system as set forth in claim 1, wherein the pulse width modulation is controlled to independently provide heating and dehumidification.

14. The refrigerant system as set forth in claim 1, wherein the pulse width modulation is controlled to reduce variations of temperature and humidity in the conditioned environment.

15. A method of controlling a refrigerant system including the steps of:
providing a compressor for compressing refrigerant and delivering it downstream to a condenser, an expansion device positioned downstream of said condenser and an evaporator positioned downstream of said expansion device;
providing a reheat circuit incorporated into said refrigerant system, said reheat circuit being operable to tap at least a portion of refrigerant from a main refrigerant circuit and pass the refrigerant through a reheat heat exchanger, the refrigerant having passed through the reheat heat exchanger being returned to the main refrigerant circuit, an air-moving device for moving air over said evaporator, and then serially over said reheat heat exchanger; and
controlling a component with pulse width modulation control to change the amount of refrigerant being compressed by said compressor to achieve precise control over both temperature and humidity provided by the refrigerant system.

16. The method as set forth in claim 15, wherein said component is a suction valve for controlling the amount of refrigerant delivered through said suction valve and to said compressor.

17. The method as set forth in claim 15, wherein said component is the compressor, and the pulse width modulation control controlling the amount of refrigerant compressed by said compressor.

18. The method as set forth in claim 17, wherein said compressor is a scroll compressor.

19. The method as set forth in claim 15, wherein said reheat heat exchanger is positioned upstream of said condenser.

20. The method as set forth in claim 15, wherein said reheat heat exchanger is positioned downstream of said condenser.

21.-34. (canceled)
